(19) United States
(12) Patent Application Publication
(10) Pub. No.: US 2010/0291356 A1
(43) Pub. Date: Nov. 18, 2010

(54) ZIRCONIA-BASED COLOR SHELL STRUCTURE OF ELECTRONIC PRODUCT

(76) Inventor: SHIH-YANG CHAN, Tu Cheng City (TW)

Correspondence Address: LEONG C. LEI, PMB # 1008, 1839 YGNACIO VALLEY ROAD, WALNUT CREEK, CA, 94598, US

(21) Appl. No.: 12/464,111

(22) Filed: May 12, 2009

(51) Int. Cl. B32B 15/04; B32B 3/00

(52) U.S. Cl. 428/195.1; 428/457

(57) ABSTRACT

A zirconia-based color shell structure includes a primer shell made of zirconia subjected to primary firing at a high temperature and a color layer formed by applying glaze(s) to the surface of the fired primer shell and subjecting the glaze(s) to secondary firing to provide a color glazed coating on the surface of the zirconia shell.

### (a) TECHNICAL FIELD OF THE INVENTION

The present invention generally relates to a zirconia-based color shell structure for an electronic product, wherein the shell structure comprises a primer shell made of zirconia subjected to primary firing at a high temperature and a color layer formed by applying glaze(s) to the surface of the fired primer shell and subjecting the glaze(s) to secondary firing to provide a colored glazed coating on the surface of the zirconia shell.

### (b) DESCRIPTION OF THE PRIOR ART

Electronic products that are currently available in the market, such as mobile phones and portable computer disk drives, have an enclosure that is made of plastics. The plastic enclosure is often subjected to a mirror surface treatment to make the surface thereof shinning and glossily. However the plastic enclosures suffer low hardness and after a long term use, the surface of the plastic enclosure may form scraping marks, affecting the aesthetics thereof.

Enclosures made of alloys of aluminum and/or magnesium are also available for electronic products. This improves the drawback of insufficient surface hardness. However, those metal enclosures are often treated with electroplating or paint baking on the surface thereof. The process of electroplating or paint baking often uses toxicant substance, which leads to pollution to the surroundings. Apparently, improvements are needed to solve the problems.

Thus, the present invention aims to solve the above discussed problems by providing a zirconia-based color shell structure for electronic products.

### SUMMARY OF THE INVENTION

The present invention provides a zirconia-based color shell structure for an electronic product, wherein zirconia is shaped and subjected to primary firing at a high temperature to form a primer shell on which glaze(s) is applied and subjected to secondary firing at a high temperature to form a color glazed coating on the surface of the zirconia primer shell.

In the zirconia-based color shell structure in accordance with the present invention, the primer shell comprises 92-98% zirconia and 2-8% yttrium and is subjected to the primary firing at a temperature of 1200-1700° C. The color layer can be formed by applying glaze on the primer shell that has been subjected to the primary firing or by attaching a sticker sheet carrying glaze to a surface of the primer shell that has been subjected to the primary firing, and then subjecting the glaze to the secondary firing to form the glazed color coating on the primer shell.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart of a process for forming a shell structure in accordance with the present invention.

FIG. 2 is a cross-sectional view illustrating the shell structure in accordance with the present invention.

FIG. 3 is a schematic view illustrating an application of the present invention in an enclosure of a mobile phone.

FIG. 4 is a schematic view illustrating an application of the present invention in an enclosure of a portable memory device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

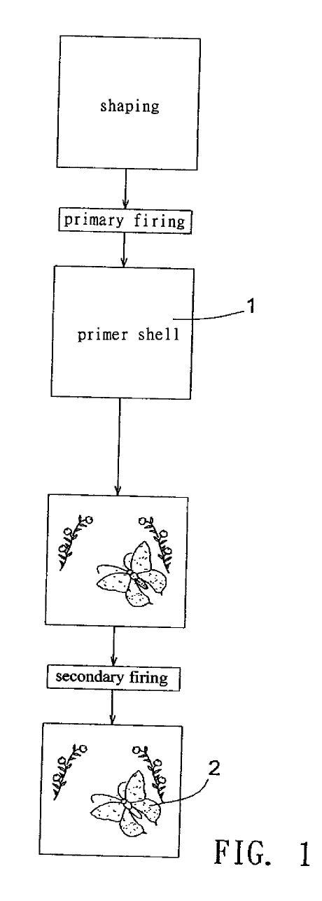

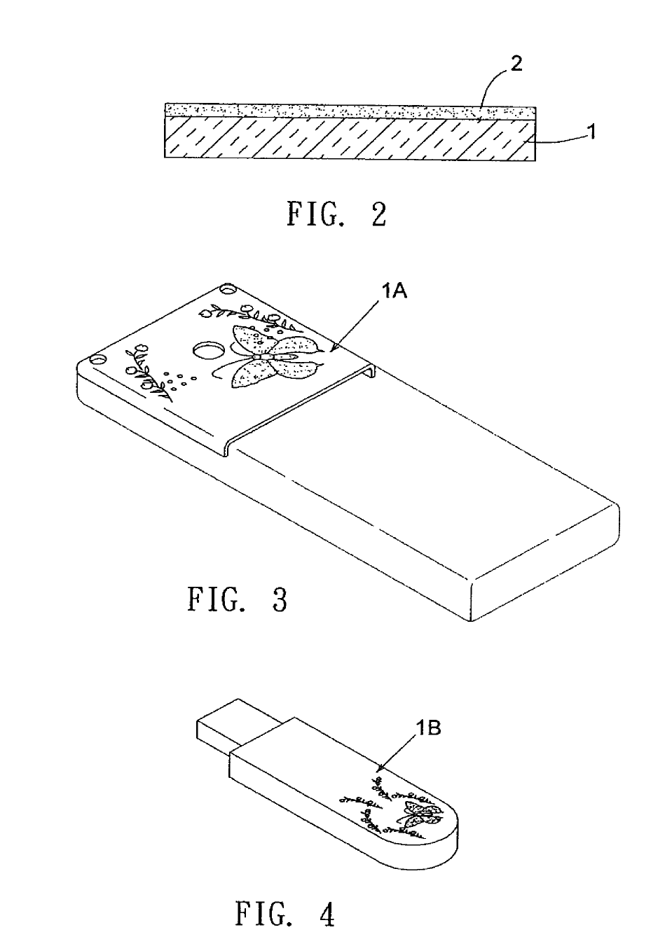

With reference to FIGS. 1 and 2, the present invention provides a zirconia-based color shell structure for an electronic product, comprising a primer shell 1 that is formed by being shaped with high purity zirconia and subjected to primary filing; and a color layer 2 that is formed with glaze applied to the primer shell 1 and subjected to secondary firing. In the zirconia-based color shell structure made in accordance with the present invention, the primer shell 1 comprises 92-98% zirconia and 2-8% yttrium and is subjected to the primary firing, which is conducted at a high temperature of 1200-1700° C.; the color layer 2 is formed by applying glaze(s) on the primer shell 1 formed with the primary firing process, or alternatively the color layer 2 is formed by attaching a sticker sheet carrying glaze(s) to the primer shell 1 and then firing at a high temperature so that the color layer 2 made of the glaze(s) is formed on the surface of the primer shell 1.

In the zirconia-based color shell in accordance with the present invention, the color layer 2 is formed by being fired at a temperature ranging from 400 to 1200° C. depending on the firing temperature of the types of glazes applied to the shell 1. The present invention is not limited to any specific glaze(s).

The zirconia-based color shell in accordance with the present invention can be applied to for example the enclosure (1A) of a mobile phone shown in FIG. 3 or an enclosure (1B) of a portable memory device shown in FIG. 4. The present invention is not limited to any specific applications.

In the zirconia-based color shell in accordance with the present invention, since the primer shell 1 is formed by firing high purity zirconia, the primer shell 1 possesses extremely high hardness, which prevents the formation of scraping marks on the surface of the shell 1. Thus, the shell 1 can maintain a new and glossily appearance even after being used for a long term.

Zirconia, after being fired, exhibits excellent characteristics in respect of hardness and has been widely used in various applications, such as cutters and knives, including surgery knives. However, zirconia has not yet been used in the applications for making enclosures of electronic products, and it is also not found that a zirconia shell is further coated or attached with glazes, followed by high temperature firing, to make a non-detachable color layer 2 on the surface of the zirconia shell 1 for improving aesthetics of the shell 1 and improving product quality.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A zirconia-based color shell structure for an electronic product, comprising:
a primer shell made by shaping high purity zirconia and being subjected to primary firing; and
a color layer formed by coating glaze on a surface of the primer shell and being subjected to secondary filing.

2. The zirconia-based color shell structure according to claim 1, wherein the primer shell comprises 92-98% zirconia and 2-8% yttrium and is subjected to the primary firing at a temperature of 1200-1700° C.

3. The zirconia-based color shell structure according to claim 1, wherein the color layer is formed by applying the glaze on the primer shell that has been subjected to the primary firing and then subjected to the secondary firing at a high temperature to form a glazed coating on the primary shell.

4. The zirconia-based color shell structure according to claim 1, wherein the color layer is formed by attaching a sticker sheet carrying the glaze to a surface of the primer shell and then subjected to firing at the high temperature to form a glazed coating on the primer shell.

5. The zirconia-based color shell structure according to claim 1, wherein the color layer is subjected to the secondary firing at a firing temperature ranging from 400 to 1200° C.

6. The zirconia-based color shell structure according to claim 1, wherein the primer shell is formed on an enclosure of a mobile phone.

7. The zirconia-based color shell structure according to claim 1, wherein the primer shell is formed on an enclosure of a portable memory device.
